(19) United States
(12) Patent Application Publication
(10) Pub. No.: US 2022/0166056 A1
(43) Pub. Date: May 26, 2022

(54) LITHIUM-ARGYRODITE-BASED SUPER-IONIC CONDUCTORS CONTAINING FULLY FILLED HALOGENS AND METHOD FOR PREPARING THE SAME

(71) Applicant: KOREA INSTITUTE OF SCIENCE AND TECHNOLOGY, Seoul (KR)

(72) Inventors: Hyoung Chul KIM, Seoul (KR); Byung Kook KIM, Seoul (KR); Jong Ho LEE, Seoul (KR); Ji Won SON, Seoul (KR); Kyung Joong YOON, Seoul (KR); HO IL JI, Seoul (KR); Sung Eun YANG, Seoul (KR); Sang Baek PARK, Seoul (KR); Hun Gi JUNG, Seoul (KR); Sung Soo SHIN, Seoul (KR); Ji Su KIM, Seoul (KR); Eu Deum JUNG, Seoul (KR)

(73) Assignee: KOREA INSTITUTE OF SCIENCE AND TECHNOLOGY, Seoul (KR)

(21) Appl. No.: 17/198,719

(22) Filed: Mar. 11, 2021

(30) Foreign Application Priority Data
Nov. 25, 2020 (KR) 10-2020-0159508

(51) Int. Cl. H01M 10/0562

(52) U.S. Cl. CPC H01M 10/0562; H01M 2300/008

(57) ABSTRACT

Provided are a lithium-argyrodite ionic superconductor containing a halogen element and a method for preparing the same, wherein an argyrodite-type crystal structure can be maintained and lithium ion conductivity can be greatly improved by combining specific elements at a specific molar ratio.

### CROSS-REFERENCE TO RELATED APPLICATION

This application claims, under 35 U.S.C. § 119A, the benefit of priority to Korean Patent Application No. 10-2020-0159508 filed on Nov. 25, 2020, the entire contents of which are incorporated herein by reference.

### BACKGROUND

### (a) Technical Field

The present invention relates to a lithium-argyrodite-based ionic superconductor containing a halogen element and a method for preparing the same, wherein an argyrodite-type crystal structure can be maintained and lithium ion conductivity can be greatly improved by combining specific elements at a specific molar ratio.

### (b) Background Art

Secondary battery technologies used for electronic devices such as cellular phones and notebooks as well as vehicles such as hybrid vehicles and electric vehicles require electrochemical devices having better stability and higher energy density.

Currently, conventional secondary battery technologies face limitations on improvement of stability and energy density because most examples thereof have cells based on an organic solvent (organic liquid electrolyte).

Meanwhile, all-solid-state batteries using inorganic solid electrolytes have recently attracted a great deal attention because they are based on technologies that obviate the use of an organic solvent and thus enable cells to be produced in a safer and simpler manner.

However, a material based on lithium-phosphorus-sulfur (Li—P—S, LPS), which is the most representative solid electrolyte for all-solid-state batteries developed to date, needs to be actively researched for mass production due to drawbacks such as low room-temperature lithium ion conductivity, the necessity for heat treatment processes, instability of crystal phases, poor atmospheric stability, process restrictions, and narrow ranges of high-conductive phase composition ratios.

U.S. Pat. No. 9,899,701 B2 reports Li₆PS₅Cl, which is a lithium-ion-conducting material having an argyrodite-type crystal structure. A crystal phase of Li₆PS₅Cl is composed of lithium (Li), phosphorus (P), sulfur (S), and chlorine (Cl), and is formed by heat treatment at a relatively high temperature for a long time after preparation of a raw-material powder. Although Li₆PS₅Cl has higher room-temperature lithium ion conductivity than conventional materials, about 2 mS/cm, high lithium ion conductivity of 10 mS/cm, similar to that of a liquid electrolyte, is required and thus application to next-generation technologies is not possible. In addition, a high-temperature heat treatment process performed over a long period of time, which is required for the process of synthesizing a material, causes an increase in manufacturing costs, a decrease in yield, and inconsistent composition, which remain major obstacles to mass production of materials.

The above information disclosed in this Background section is provided only for enhancement of understanding of the background of the invention, and therefore it so may contain information that does not form the prior art that is already known in this country to a person of ordinary skill in the art.

### SUMMARY OF THE DISCLOSURE

The present invention has been made in an effort to solve the above-described problems associated with the prior art.

It is an object of the present invention to provide a solid electrolyte having high lithium ion conductivity and a method for preparing the same.

The objects of the present invention are not limited to those mentioned above. The objects of the present invention will be clearly understood from the following description and implemented by means described in the claims and combinations thereof.

In one aspect, the present invention provides a solid electrolyte represented by the following Formula 1 and having an argyrodite-type crystal structure:

Li₅₊ₐ(M1ₐM2₁₋ₐ)(A1_{b}A2_{4-b})(X1_{c}X2_{2-c}) (1)

wherein M1 includes at least one crystallogenic element selected from the group consisting of carbon (C), silicon (Si), germanium (Ge), tin (Sn) and lead (Pb) elements and combinations thereof, M2 includes at least one pnictogen element so selected from the group consisting of nitrogen (N), phosphorus (P), arsenic (As), antimony (Sb) and bismuth (Bi) elements and combinations thereof, A1 and A2 each include at least one chalcogen element selected from the group consisting of oxygen (O), sulfur (S), selenium (Se) and tellurium (Te) elements and combinations thereof, X1 and X2 each include at least one halogen element selected from the group consisting of fluorine (F), chlorine (CI), bromine (Br) and iodine (I) elements and combinations thereof, and a, b and c satisfy 0≤a≤1, 0≤b≤4, and 0≤c≤2.

In another aspect, the present invention provides a solid electrolyte represented by the following Formula 2 and having an argyrodite-type crystal structure:

Li_{5+a+d}(M1ₐM2₁₋ₐ)(A1_{b}A2_{4-b}(X1_{c}X2_{2-c}) (2)

wherein M1 includes at least one crystallogenic element selected from the group consisting of carbon (C), silicon (Si), germanium (Ge), tin (Sn) and lead (Pb) elements and combinations thereof, M2 includes at least one pnictogen element selected from the group consisting of nitrogen (N), phosphorus (P), arsenic (As), antimony (Sb) and bismuth (Bi) elements and combinations thereof, A1 and A2 each include at least one chalcogen element selected from the group consisting of oxygen (O), sulfur (S), selenium (Se) and tellurium (Te) elements and combinations thereof, X1 and X2 each include at least one halogen element selected from the group consisting of fluorine (F), chlorine (Cl), bromine (Br) and iodine (I) elements and combinations thereof, and a, b, c and d satisfy 0≤a≤1, 0≤b≤4, 0≤c≤2 and −1≤d≤1.

The solid electrolyte may have peaks in ranges of 2θ=14.86°±0.50°, 17.12°±0.50°, 24.20°±0.50°, 28.38°±0.50°, 29.66°±0.50°, 34.34°±0.50°, 38.55°±0.50°, 42.40°±0.50°, 45.07°±0.50°, 49.29°±0.50° and 55.55°±0.50° upon measurement of X-ray diffraction (XRD) patterns using a CuKα-ray.

The solid electrolyte may satisfy the following Equation 1:

40%<I₍₁₁₁₎/I₍₂₀₀₎×100<70% (1)

wherein I₍₁₁₁₎ is the diffraction intensity of an XRD peak at 2θ=14.86°±0.50°, and I₍₂₀₀₎ is the diffraction intensity of an XRD peak at 2θ=17.15°±0.50°.

The solid electrolyte may have a ⁷Li-NMR spectrum peak at 5.8±0.5 ppm and 0±0.5 ppm.

The solid electrolyte may satisfy the following Equation 2:

0%<I_{Peak-1}/I_{Peak-2}×100<20% (2)

wherein Iₚₑₐₖ₋₁ is an intensity of a ⁷Li-NMR spectrum peak at −5.8 ppm, and Iₚₑₐₖ₋₂ is an intensity of a ⁷Li-NMR spectrum peak at 0 ppm.

The solid electrolyte may have an Sb-XPS spectrum at 526 eV to 535 eV, and the spectrum may be divided into four main peaks.

The solid electrolyte may satisfy the following Equation 3:

0.20<Aₚₑₐₖ₋₃/(A_{Peak-1}+A_{Peak-2}+A_{Peak-3}+A_{Peak-4})<0.45 (3)

wherein Aₚₑₐₖ₋₁ is an area of a Sb-XPS peak at a binding energy of 528.81±0.3 eV, Aₚₑₐₖ₋₂ is an area of a Sb-XPS peak at a binding energy of 529.54±0.3 eV, Aₚₑₐₖ₋₃ is an area of a Sb-XPS peak at a binding energy of 530.52±0.3 eV, and Aₚₑₐₖ₋₄ is an area of a Sb-XPS peak at a binding energy of 532.04±0.3 eV.

In another aspect, the present invention provides a method for preparing a solid electrolyte including adding at least one element selected from the group consisting of a crystallogenic element, a pnictogen element, a chalcogen element and combinations thereof to a mixture containing lithium chalcogenide (Li₂A), chalcogenide (MSₓ) and lithium halide (LiX) to prepare a starting material and grinding the starting material.

The method may further include heat-treating the ground mixture at a temperature of 30° C. to 1,000° C. for 10 seconds to 1,000 hours.

Other aspects and preferred embodiments of the invention are discussed infra.

### BRIEF DESCRIPTION OF THE DRAWINGS

The above and other features of the present invention will now be described in detail with reference to certain exemplary embodiments thereof illustrated in the accompanying drawings which are given hereinbelow by way of illustration only, and thus are not limitative of the present invention, and wherein:

FIG. 1 shows the result of measuring ionic conductivity of solid electrolytes according to Examples 1 to 5 and Comparative Examples 1 and 2 of the present invention;

FIG. 2 shows the result of XRD analysis of solid electrolytes according to Examples 1 to 5 and Comparative Examples 1 and 2 of the present invention;

FIG. 3 shows the result of ⁷Li-NMR analysis of the solid electrolytes according to Examples 1 to 5 and Comparative Examples 1 and 2 of the present invention;

FIG. 4 shows the result of Sb-XPS analysis of the solid electrolytes according to Examples 1 to 5 and Comparative Examples 1 and 2 of the present invention;

FIG. 5 shows the result of measuring ionic conductivity of the solid electrolytes according to Examples 3 and 6 to 9 of the present invention; and

FIG. 6 shows the result of XRD analysis of the solid electrolytes according to Example 3 and Examples 6 to 9 of the present invention.

### DETAILED DESCRIPTION

The objects described above, as well as other objects, features and so advantages, will be clearly understood from the following preferred embodiments with reference to the attached drawings. However, the present invention is not limited to the embodiments, and may be embodied in different forms. The embodiments are suggested only to enable a thorough and complete understanding of the disclosed context and to sufficiently inform those skilled in the art of the technical concept of the is present invention.

Like reference numbers refer to like elements throughout the description of the figures. In the drawings, the sizes of structures may be exaggerated for clarity. It will be understood that, although the terms “first”, “second”, etc. may be used herein to describe various elements, these elements should not be construed as being limited by these terms, which are used only to distinguish one element from another. For example, within the scope defined by the present invention, a first element may be referred to as a second element, and similarly, a second element may be referred to as a first element. Singular forms are intended to include plural forms as well, unless the context clearly indicates otherwise.

It will be further understood that the terms “comprises”, “has” and the like, when used in this specification, specify the presence of stated features, numbers, steps, operations, elements, components or combinations thereof, but do not preclude the presence or addition of one or more other features, numbers, steps, operations, elements, components, or combinations thereof. In addition, it will be so understood that, when an element such as a layer, film, region or substrate is referred to as being “on” another element, it can be directly on the other element, or an intervening element may also be present. It will also be understood that, when an element such as a layer, film, region or substrate is referred to as being “under” another element, it can be directly under the other element, or an intervening element may also be present.

Unless the context clearly indicates otherwise, all numbers, figures and/or expressions that represent ingredients, reaction conditions, polymer compositions and amounts of mixtures used in the specification are approximations that reflect various uncertainties of measurement occurring inherently in obtaining these figures, among other things. For this reason, it should be understood that, in all cases, the term “about” should be understood to modify all numbers, figures and/or expressions. In addition, when numerical ranges are disclosed in the description, these ranges are continuous and include all numbers from the minimum to the maximum including the maximum within the range unless otherwise defined. Furthermore, when the range refers to an integer, it includes all integers from the minimum to the maximum including the maximum within the range, unless otherwise defined.

The lithium-argyrodite ion conductor described above refers to a material that conducts lithium ions and has an argyrodite-type crystal structure. Hereinafter, the lithium-argyrodite ion conductor will be abbreviated as “argyrodite solid electrolyte” or “solid electrolyte”.

The argyrodite solid electrolyte according to an embodiment of the present invention may be represented by the following Formula 1:

Li₅₊(M1ₐM2₁₋ₐ)(A1_{b}A2_{4-b})(X1_{c}X2_{2-c}) (1)

wherein M1 includes at least one crystallogenic element selected from the group consisting of carbon (C), silicon (Si), germanium (Ge), tin (Sn) and lead (Pb) elements and combinations thereof,

M2 includes at least one pnictogen element selected from the group consisting of nitrogen (N), phosphorus (P), arsenic (As), antimony (Sb) and bismuth (Bi) elements and combinations thereof,

A1 and A2 each include at least one chalcogen element selected from the group consisting of oxygen (O), sulfur (S), selenium (Se) and tellurium (Te) elements and combinations thereof,

X1 and X2 each include at least one halogen element selected from the group consisting of fluorine (F), chlorine (CI), bromine (Br) and iodine (I) elements and combinations thereof, and
a, b and c satisfy 0≤a≤1, 0≤b≤4, and 0≤c≤2.

Meanwhile, the argyrodite solid electrolyte according to another embodiment of the present invention may be represented by the following Formula 2:

Li_{5+a+d}(M1 ₐM2₁₋ₐ)(A1_{b}A2_{4-b}(X1_{c}X2_{2-c}) (2)

wherein M1, M2, A1, A2, X1 and X2 are as defined in Formula 1 above, and

a, b, c and d satisfy 0≤a≤1, 0≤b≤4, 0≤c≤2 and −1≤d≤1.

A sulfide-based solid electrolyte having an argyrodite-based crystal structure of the prior art may be represented by Li₆PS₅Cl. The argyrodite solid electrolyte according to the present invention has a basic structure of Li₅MA₄X₂ (in which M is a crystallogenic element and/or a pnictogen element, A is a chalcogen element, and X is a halogen element), which is completely different from that of the conventional compound. The present inventors used two or more M elements (M1, M2) and two or more X elements (X1, X2) as shown in Formula 1 above to introduce a halogen element into the positions 4a and 4c in the argyrodite-type crystal structure as much as possible. As a result, a solid electrolyte having high crystallinity and lithium ion conductivity could be formed.

The method for preparing a solid electrolyte according to an embodiment of the present invention includes adding at least one element selected from the group consisting of a crystallogenic element, a pnictogen element, a chalcogen element and combinations thereof to a mixture containing lithium chalcogenide (Li₂A), chalcogenide (MSₓ) and lithium halide (LiX) to prepare a starting material and grinding the starting material.

As used herein, the term “single substance (or simple substance)” refers to a substance that includes only one type or single type of element and thus exhibits the inherent chemical properties thereof.

The starting material may be prepared by weighing appropriate compounds in appropriate amounts to obtain the composition of Formula 1 and/or Formula 2. The lithium chalcogenide (Li₂A) may include lithium sulfide (Li₂S) or the like.

The chalcogenide (MSₓ) may include silicon sulfide (SiS₂), antimony sulfide (Sb₂S₃), or the like.

The lithium halide (LiX) may include lithium chloride (LiCI), lithium bromide (LiBr), lithium iodide (LiI), or the like.

The starting material may be prepared by adding a element to the mixture containing lithium chalcogenide (Li₂A), chalcogenide (MSₓ) and the lithium halide (LiX).

For example, in Formula 1 and/or Formula 2, wherein M1 is silicon (Si), M2 is antimony (Sb), X1 is bromine (Br), and X2 is iodine (I), the desired composition of

Formula 1 and/or Formula 2 can be adjusted by adding elemental sulfur (S) to a mixture containing lithium sulfide (Li₂S), silicon sulfide (SiS₂), antimony sulfide (Sb₂S₃), lithium bromide (LiBr) and lithium iodide (LiI).

In addition, according to the present invention, the ratio of a lithium (Li) element may be changed to balance the charge in a Li₅MA₄X₂-type structure by adjusting the ratio of silicon sulfide (SiS₂) and antimony sulfide (Sb₂S₃), as raw materials other than lithium sulfide (Li₂S) and lithium halide (LiX). In some cases, lithium (Li) may be added and introduced in excess, beyond the charge balance.

The present invention is characterized in that the starting material is ground with strong force to deliver a high temperature and a high pressure to the starting material. An argyrodite-type solid electrolyte in which all of the halogen elements of a high concentration enter the 4a and 4c sites in the crystal can be synthesized by grinding the starting material with a strong force. The grinding method is not particularly limited, but may be conducted using a ball mill such as an electric ball mill, a vibrating ball mill or planetary ball mill, a vibrating mixer mill, a SPEX mill or the like, preferably, using a planetary ball mill. Specifically, when raw materials and beads are charged in a container and the planetary ball mill is then operated, the beads in the container rotate along the wall of the container and the raw materials are ground by friction. At this time, different grinding conditions can be applied by changing the speed of rotation and variously controlling the process time according to each speed of rotation. In addition, the equilibrium temperature applied during grinding can be controlled by adding an external cooling or heating device during grinding to provide optimized conditions for synthesis of the crystal phase.

In addition, the method for preparing a sulfide-based solid electrolyte according to the present invention may further include heat-treating the ground mixture. The conditions for heat treatment are not particularly limited, but may include a temperature higher than the crystallization temperature of the ground mixture. For example, the heat treatment may be carried out by heat-treating the ground mixture at 30° C. to 1,000° C. for 10 seconds to 1,000 hours. However, based on the characteristics of the Li₅MA₄X₂-type argyrodite structure, in which a very high concentration of halogen is introduced, a secondary phase may be generated by heat treatment, and thus lithium ion conductivity may be greatly lowered.

The argyrodite-based solid electrolyte prepared by the method described above has properties completely different from those of conventional materials. This will be analyzed in the following Examples and Test Examples.

### EXAMPLE 1

### Synthesis of Li₅SbS₄Br_{0.3}I_{1.7} (M2=Sb; A2=S; X1=Br; X2=I; a=0; b=0; c=0.3)

A starting material containing lithium sulfide (Li₂S), antimony sulfide (Sb₂S₃), lithium bromide (LiBr), lithium iodide (LiI), and elemental sulfur (S) at a molar ratio of 0.131:0.324:0.050:0.434:0.061 was prepared.

The starting material was charged in an airtight milling container along with beads made of zirconium oxide (ZrO₂) and having a diameter of 3 mm. Here, the amount of charged beads was about 20 times the weight of the raw materials. The mixture was ground using the planetary ball mill method generating a high inertial force described above. Specifically, the container was rotated so as to apply a g-force of about 49G to the mixture, and a cycle including grinding for 30 minutes and allowing the mixture to stand for 30 minutes was repeated 18 times.

After completion of grinding, an argyrodite solid electrolyte was recovered through appropriate sieving.

### EXAMPLE 2

### Synthesis of Li_{5.1}Si_{0.1}Sb_{0.9}S₄Br_{0.3}I_{1.7} (M1=Si; M2=Sb; A2=S; X1=Br; X2=I; a=0.1; b=0; c=0.3)

A starting material containing lithium sulfide (Li₂S), silicon sulfide (SiS₂), antimony sulfide (5b₂5₃), lithium bromide (LiBr), lithium iodide (LiI), and elemental sulfur (S) at a molar ratio of 0.138:0.018:0.296:0.051:0.441:0.056 was prepared.

Grinding and synthesis were conducted in the same manner as in Example 1 above to obtain a powdery argyrodite-based solid electrolyte.

### EXAMPLE 3

### Synthesis of Li_{5.2}Si_{0.2}Sb_{0.8}S₄Br_{0.3}I_{1.7} (M1=Si; M2=Sb; A2=S; X1=Br; X2=I; a=0.2; b=0; c=0.3)

A starting material containing lithium sulfide (Li₂S), silicon sulfide (SiS₂), antimony sulfide (Sb₂S₃), lithium bromide (LiBr), lithium iodide (LiI), and elemental sulfur (S) at a molar ratio of 0.145:0.036:0.268:0.051:0.449:0.051 was prepared.

Grinding and synthesis were conducted in the same manner as in Example 1 above to obtain a powdery argyrodite-based solid electrolyte.

### EXAMPLE 4

### Synthesis of Li_{5.3}Si_{0.3}Sb_{0.7}S₄Br_{0.3}I_{1.7} (M1=Si; M2=Sb; A2=S; X1=Br; X2=I; a=0.3; b=0; c=0.3)

A starting material containing lithium sulfide (Li₂S), silicon sulfide (SiS₂), antimony sulfide (Sb₂S₃), lithium bromide (LiBr), lithium iodide (LiI), and elemental sulfur (S) at a molar ratio of 0.152:0.056:0.239:0.052:0.457:0.045 was prepared.

Grinding and synthesis were conducted in the same manner as in Example 1 above to obtain a powdery argyrodite-based solid electrolyte.

### EXAMPLE 5

### Synthesis of Li_{5.4}Si_{0.4}Sb_{0.6}S₄Br_{0.3}I_{1.7} (M1=Si; M2=Sb; A2=S; X1=Br; X2=I; a=0.4; b=0; c=0.3)

A starting material containing lithium sulfide (Li₂S), silicon sulfide (SiS₂), antimony sulfide (Sb₂S₃), lithium bromide (LiBr), lithium iodide (LiI), and elemental sulfur (S) at a molar ratio of 0.160:0.075:0.208:0.053:0.465:0.039 was prepared.

Grinding and synthesis were conducted in the same manner as in Example 1 above to obtain a powdery argyrodite-based solid electrolyte.

### EXAMPLE 6

### Synthesis of Li_{5.2}Si_{0.2}Sb_{0.8}S₄I₂ (M1=Si; M2=Sb; A2=S; X2=I; a=0.2; b=0; c=0)

A starting material containing lithium sulfide (Li₂S), silicon sulfide (SiS₂), antimony sulfide (Sb₂S₃), lithium bromide (LiBr), lithium iodide (LiI), and elemental sulfur (S) at a molar ratio of 0.141:0.035:0.261:0.514:0.049 was prepared.

Grinding and synthesis were conducted in the same manner as in Example 1 above to obtain a powdery argyrodite-based solid electrolyte.

### EXAMPLE 7

### Synthesis of Li_{5.2}Si_{0.2}Sb_{0.8}S₄Br_{0.2}I_{1.8} (M1=Si; M2=Sb; A2=S; X1=Br; X2=I; a=0.2; b=0; c=0.2)

A starting material containing lithium sulfide (Li₂S), silicon sulfide (SiS₂), antimony sulfide (Sb₂S₃), lithium bromide (LiBr), lithium iodide (LiI), and elemental sulfur (S) at a molar ratio of 0.144:0.036:0.266:0.034:0.471:0.050 was prepared.

Grinding and synthesis were conducted in the same manner as in Example 1 above to obtain a powdery argyrodite-based solid electrolyte.

### EXAMPLE 8

### Synthesis of Li_{5.2}Si_{0.2}Sb_{0.8}S₄Br_{0.25}I_{1.75} (M1=Si; M2=Sb; A2=S; X1=Br; X2=I; a=0.2; b=0; c=0.25)

A starting material containing lithium sulfide (Li₂S), silicon sulfide (SiS₂), antimony sulfide (Sb₂S₃), lithium bromide (LiBr), lithium iodide (LiI), and elemental sulfur (S) at a molar ratio of 0.144:0.036:0.267:0.043:0.460:0.050 was prepared.

Grinding and synthesis were conducted in the same manner as in Example 1 above to obtain a powdery argyrodite-based solid electrolyte.

### EXAMPLE 9

### Synthesis of Li_{5.2}Si_{0.2}Sb_{0.8}S₄Br_{0.4}I_{1.6} (M1=Si; M2=Sb; A2=S; X1=Br; X2=I; a=0.2; b=0; c=0.4)

A starting material containing lithium sulfide (Li₂S), silicon sulfide (SiS₂), antimony sulfide (Sb₂S₃), lithium bromide (LiBr), lithium iodide (LiI), and elemental sulfur (S) at a molar ratio of 0.146:0.037:0.270:0.069:0.426:0.051 was prepared.

Grinding and synthesis were conducted in the same manner as in Example 1 above to obtain a powdery argyrodite-based solid electrolyte.

### EXAMPLE 10

### Synthesis of Li_{5.3}Si_{0.2}Sb_{0.8}S₄Br_{0.25}I_{1.75} (M1=Si; M2=Sb; A2=S; X1=Br; X2=I; a=0.2; b=0; c=0.25; d=0.1)

A starting material containing lithium sulfide (Li₂S), silicon sulfide (SiS₂), antimony sulfide (Sb₂S₃), lithium bromide (LiBr), lithium iodide (LiI), and elemental sulfur (S) at a molar ratio of 0.149:0.036:0.266:0.043:0.460:0.047 was prepared.

Grinding and synthesis were conducted in the same manner as in Example 1 above to obtain a powdery argyrodite-based solid electrolyte.

### Comparative Example 1

### Synthesis of Li_{6.2}Si_{0.2}Sb_{0.8}S₅I

A mixture containing lithium sulfide (Li₂S), silicon sulfide (SiS₂), antimony sulfide (Sb₂S₃), lithium iodide (LiI), and elemental sulfur (S) at a molar ratio of 0.276:0.043:0.314:0.309:0.059 was prepared.

Grinding and heat treatment were conducted in the same manner as in Example 1 above to obtain a powdery argyrodite-based solid electrolyte.

### Comparative Example 2

### Synthesis of Li_{6.6}Si_{0.6}Sb_{0.4}S₅I

A mixture containing lithium sulfide (Li₂S), silicon sulfide (SiS₂), antimony sulfide (Sb₂S₃), lithium iodide (LiI), and elemental sulfur (S) at a molar ratio of 0.323:0.139:0.170:0.336:0.032 was prepared.

Grinding and heat treatment were conducted in the same manner as in Example 1 above to obtain a powdery argyrodite-based solid electrolyte.

### Test Example 1

### Observation of Crystal Characteristics of Synthesized Sample Through Measurement of Alternating-Current Impedance

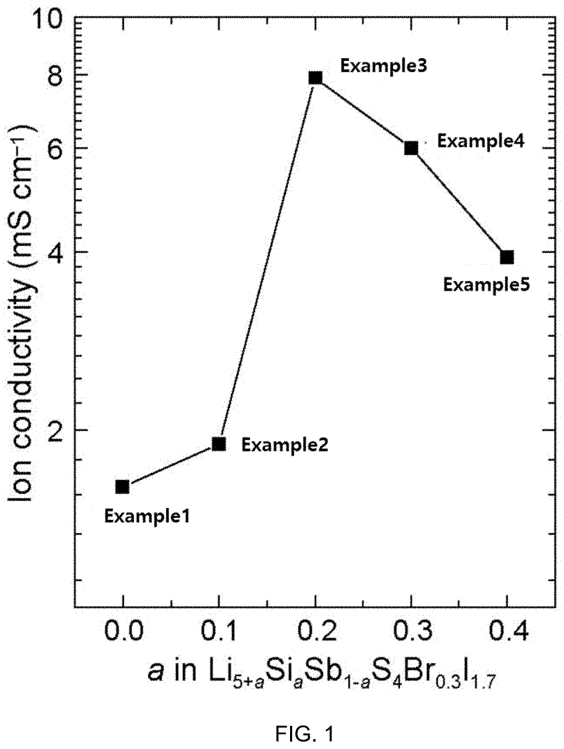

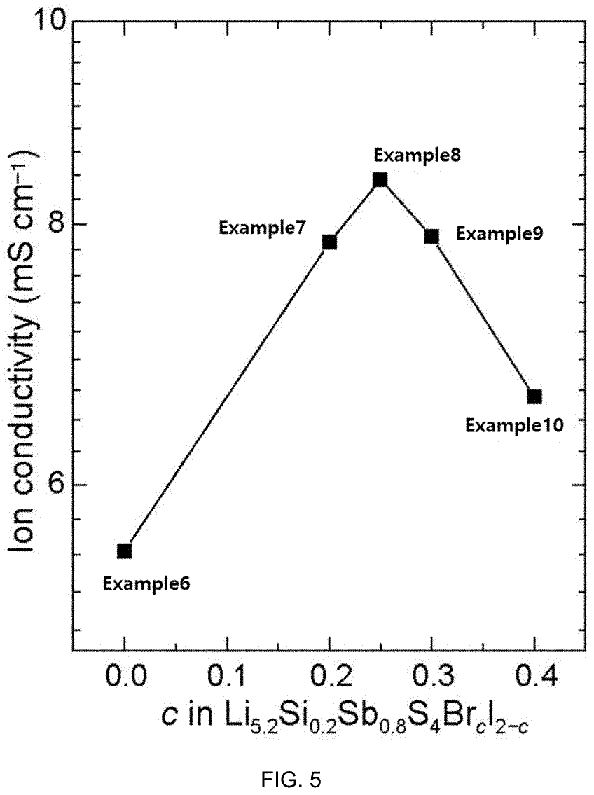

Alternating-current impedance analysis was conducted at room temperature in order to measure the lithium ion conductivity of argyrodite-based solid electrolytes according to Examples 1 to 10 and Comparative Examples 1 and 2. Each powder was charged in a mold for measuring conductivity, and a sample having a diameter of 6 mm and a thickness of 2.5 mm was produced through uniaxial cold pressing at 300 MPa. An alternating-current voltage of 100 mV was applied to the sample, and a frequency sweep was conducted from 1 Hz to 3 MHz to determine the impedance of the sample. The results are shown in FIGS. 1 and 5 and Table 1.

TABLE 1

| | | | | | | | | | | | | Ionic |
|---|---|---|---|---|---|---|---|---|---|---|---|---|
| | | | | | | | | | | | | con- |
| | | | | | | | | | | | | ductivity |
| Item | Formula | M1 | M2 | A1 | A2 | X1 | X2 | a | b | c | d | (mS/cm) |
| Example | Li₅SbS₄Br_{0.3}I_{1.7} | — | Sb | — | S | Br | I | 0 | 0 | 0 | — | 1.60 |
| 1 | | | | | | | | | | | | |
| Example | Li_{5.1}Si_{0.1}Sb_{0.9}S₄Br_{0.3}I_{1.7} | Si | Sb | — | S | Br | I | 0.1 | 0 | 0 | — | 1.89 |
| 2 | | | | | | | | | | | | |
| Example | Li_{5.2}Si_{0.2}Sb_{0.8}S₄Br_{0.3}I_{1.7} | Si | Sb | — | S | Br | I | 0.2 | 0 | 0 | — | 7.89 |
| 3 | | | | | | | | | | | | |
| Example | Li_{5.3}Si_{0.3}Sb_{0.7}S₄Br_{0.3}I_{1.7} | Si | Sb | — | S | Br | I | 0.3 | 0 | 0 | — | 6.01 |
| 4 | | | | | | | | | | | | |
| Example | Li_{5.4}Si_{0.4}Sb_{0.6}S₄Br_{0.3}I_{1.7} | Si | Sb | — | S | Br | I | 0.4 | 0 | 0 | — | 3.92 |
| 5 | | | | | | | | | | | | |
| Example | Li_{5.2}Si_{0.2}Sb_{0.8}S₄I₂ | Si | Sb | — | S | — | I | 0.2 | 0 | 0 | — | 5.58 |
| 6 | | | | | | | | | | | | |
| Example | Li_{5.2}Si_{0.2}Sb_{0.8}S₄Br_{0.2}I_{1.8} | Si | Sb | — | S | Br | I | 0.2 | 0 | 0.2 | — | 7.84 |
| 7 | | | | | | | | | | | | |
| Example | Li_{5.2}Si_{0.2}Sb_{0.8}S₄Br_{0.25}I_{1.75} | Si | Sb | — | S | Br | I | 0.2 | 0 | 0.25 | — | 8.40 |
| 8 | | | | | | | | | | | | |
| Example | Li_{5.2}Si_{0.2}Sb_{0.8}S₄Br_{0.4}I_{1.6} | Si | Sb | — | S | Br | I | 0.2 | 0 | 0.4 | — | 6.61 |
| 9 | | | | | | | | | | | | |
| Example | Li_{5.3}Si_{0.2}Sb_{0.8}S₄Br_{0.25}I_{1.75} | Si | Sb | — | S | Br | I | 0.2 | 0 | 0.25 | 0.1 | 9.25 |
| 10 | | | | | | | | | | | | |
| Com- | Li_{6.2}Si_{0.2}Sb_{0.8}S₅I₂ | — | — | — | — | — | — | — | — | — | — | 0.60 |
| parative | | | | | | | | | | | | |
| Example | | | | | | | | | | | | |
| 1 | | | | | | | | | | | | |
| Com- | Li_{6.6}Si_{0.6}Sb_{0.4}S₅I₂ | — | — | — | — | — | — | — | — | — | — | 2.73 |
| parative | | | | | | | | | | | | |
| Example | | | | | | | | | | | | |
| 2 | | | | | | | | | | | | |

As can be seen from the results of Comparative Examples 1 and 2 and Examples 1 to 10, a solid electrolyte having a Li₅MA₄X₂-type argyrodite-type crystal structure, realized by introducing as much of a halogen element possible at positions 4a and 4c in the argyrodite crystal structure as in the present invention, has lithium ion conductivity of up to 3.38 times higher than that reported in the literature and that of conventional materials (Comparative Examples 1 and 2), represented by Li₆PS₅Cl or the like, under conditions in which no heat treatment is performed. In particular, Example 10, found to have the maximum ionic conductivity of 9.25 mS/cm, was a sample to which d=0.1 was further applied, unlike Example 8, and exhibits improved ionic conductivity compared to the case in which lithium, which is a carrier ion in the material, was applied in excess. For reference, Comparative Example is an argyrodite-based solid electrolyte having an Li₆MA₅I₂ crystal structure, which was published and reported in J. Am. Chem. Soc. Vol. 141, Page 19002, and Comparative Examples use the same silicon and antimony as the cation as Examples of the present invention, and have a similar cation ratio thereto.

### Test Example 2

### Observation of Crystal Structure of Synthesized Sample Through XRD Analysis

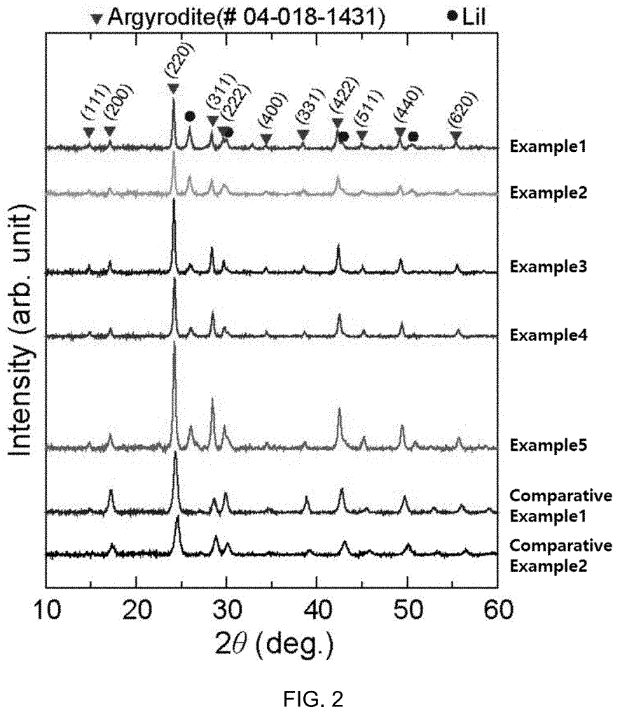

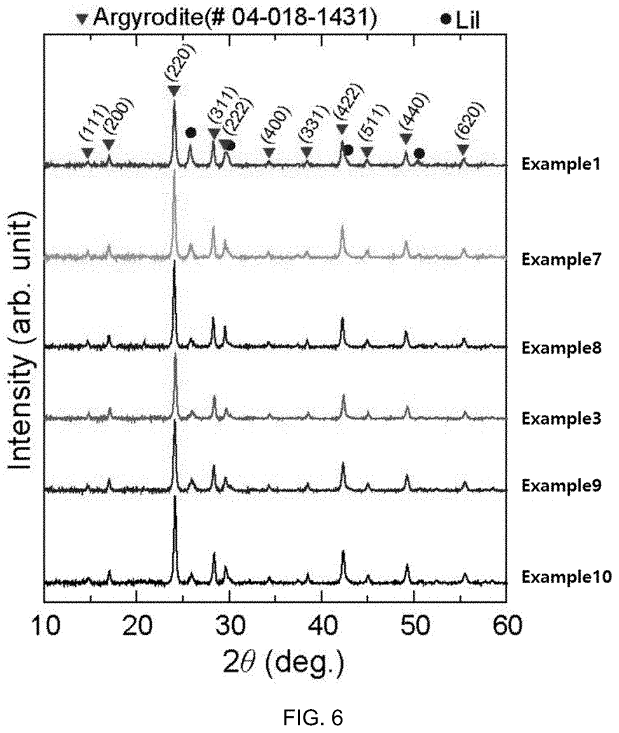

X-ray diffraction (XRD) analysis was conducted in order to analyze the crystal structures of the argyrodite-based solid electrolytes according to Examples 1 to 10 and Comparative Examples 1 and 2. Each sample was loaded on a sealed holder for XRD applications and was measured throughout a range of 10°≤2θ≤70° at a scanning rate of 2°/min. The results are shown in FIGS. 2 and 6.

As can be seen from FIGS. 2 and 6, the argyrodite-based solid electrolyte showed peaks in ranges of 2θ=14.86°±0.50°, 17.12°±0.50°, 24.20°±0.50°, 28.38°±0.50°, 29.66°±0.50°, 34.34±0.50°, 38.55°±0.50°, 42.40°±0.50°, 45.07°±0.50°, 49.29 °±0.50° and 55.55±0.50° when X-ray diffraction (XRD) patterns were measured so using a CuKα-ray. These peaks correspond exactly with the peaks appearing in the crystal structure (#04-018-1431) of argyrodite. Therefore, this indicates that the argyrodite-based solid electrolyte according to the present invention has an argyrodite-type crystal structure. In addition, the intensity ratio between the (111) and (200) peaks observed in Examples 1 to 10 and Comparative Examples 1 and 2 are is shown in Table 2 below.

TABLE 2

| Item | I₍₁₁₁₎/I₍₂₀₀₎ × 100(%) |
|---|---|
| Example 1 | 69.77 |
| Example 2 | 50.15 |
| Example 3 | 50.95 |
| Example 4 | 50.37 |
| Example 5 | 40.14 |
| Example 6 | 49.43 |
| Example 7 | 44.61 |
| Example 8 | 57.61 |
| Example 9 | 43.53 |
| Example 10 | 52.05 |
| Comparative Example 1 | 14.03 |
| Comparative Example 2 | 0.00 |

This indicates that the argyrodite-based solid electrolyte according to the present invention satisfies Equation 1 below:

40%<I₍₁₁₁₎/I_{(200)×}100<70% (1)

wherein I₍₁₁₁₎ is the diffraction intensity of an XRD peak at 2θ=14.86°±0.50° and I₍₂₀₀₎ is the diffraction intensity of an XRD peak at 2θ=17.12°±0.50°.

### Test Example 3

### Observation of Crystal Characteristics of Synthesized Sample Through ⁷Li-NMR Analysis

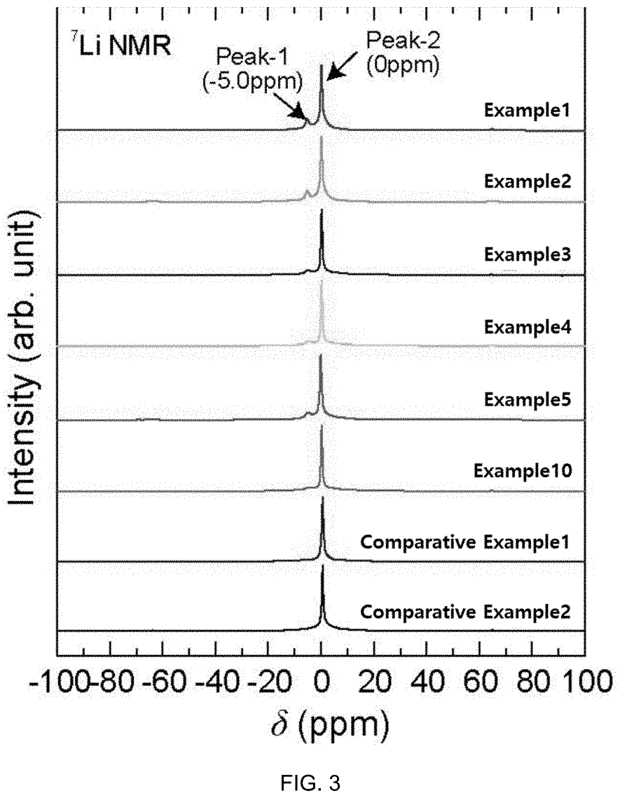

⁷Li-NMR analysis was performed to evaluate chemical changes in the argyrodite-based solid electrolytes according to Examples 1 to 5 and 10, and Comparative Examples 1 and 2. Each sample was placed in a sealed container for NMR and observed using a probe at a spinning rate of 10,000 Hz. The received information was converted into a usable data form through Fourier transform. The results are shown in FIG. 3.

As can be seen from FIG. 3, the argyrodite-based solid electrolytes according to Examples 1 to 5 and 10 and Comparative Examples 1 and 2 showed peaks in ranges of −5.8±0.5 ppm to 0±0.5 ppm in the ⁷Li-NMR spectrum. In addition, the intensity ratios between Peak−1 and Peak−2 observed in Examples 1 to 5 and 10 and Comparative Examples 1 and 2 are shown in Table 3 below.

TABLE 3

| Item | I_{Peak-1}/I_{Peak-2} × 100(%) |
|---|---|
| Example 1 | 17.17 |
| Example 2 | 16.16 |
| Example 3 | 6.06 |
| Example 4 | 7.00 |
| Example 5 | 11.11 |
| Example 10 | 5.30 |
| Comparative Example 1 | 0.00 |
| Comparative Example 2 | 0.00 |

This indicates that the argyrodite-based solid electrolyte according to the present invention satisfies Equation 2 below:

0%<I_{Peak-1}/I_{Peak-2}×100<20% (2)

wherein Iₚₑₐₖ₋₁ is an intensity of a ⁷Li-NMR spectrum peak at −5.8 ppm, and Iₚₑₐₖ₋₂ is an intensity of a ⁷Li-NMR spectrum peak at 0 ppm.

### Test Example 4

### Observation of Crystal Characteristics of Synthesized Sample Through XPS Analysis

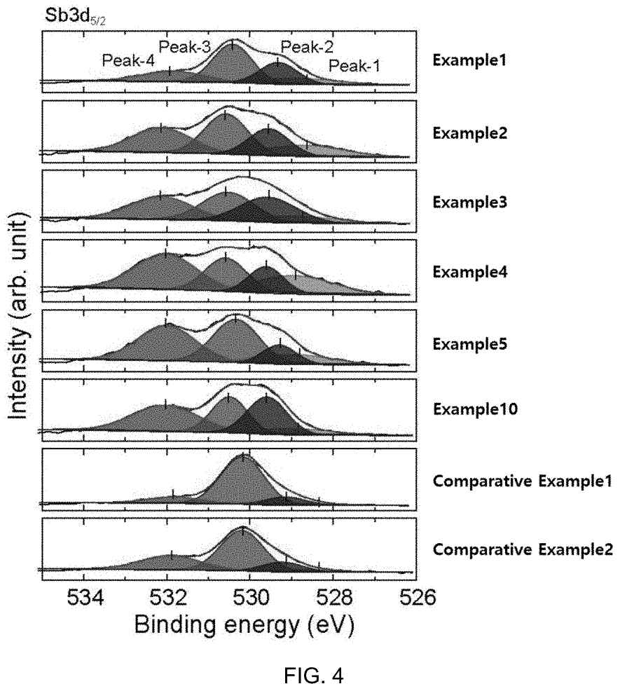

Sb-XPS analysis was performed to analyze the crystal properties of the argyrodite solid electrolytes according to Examples 1 to 5 and 10 and Comparative Examples 1 and 2. Each sample was loaded on a vacuum transfer vessel, a monochromated Al Kα having 1486.6 eV was irradiated to a beam irradiation area of 100 μm×100 μm, and the amount of photoelectrons emitted from the sample was measured. The results are shown in FIG. 4.

First, as can be seen from Table 4 below, unlike Comparative Examples 1 and 2, the argyrodite solid electrolytes of Examples 1 to 5 and 10 have an antimony (Sb) spectrum measured by X-ray photovoltaic spectroscopy (XPS) at 526 eV to 535 eV, and the spectrum is divided into four main peaks.

TABLE 4

| | | | | | A_{Peak-3}/ |
|---|---|---|---|---|---|
| | | | | | A_{Peak-1} + A_{Peak-2} + |
| Item | A_{Peak-1} | A_{Peak-2} | A_{Peak-3} | A_{Peak-4} | A_{Peak-3} + A_{Peak-4}) |
| Example 1 | 1325 | 2172 | 3565 | 1667 | 0.41 |
| Example 2 | 1617 | 1980 | 3148 | 2629 | 0.34 |
| Example 3 | 846 | 2224 | 2332 | 2191 | 0.31 |
| Example 4 | 2285 | 1448 | 2181 | 3429 | 0.23 |
| Example 5 | 875 | 773 | 2418 | 2430 | 0.37 |
| Example 10 | 901 | 2675 | 2345 | 3070 | 0.26 |
| Comparative | 427 | 817 | 4982 | 726 | 0.72 |
| Example 1 | | | | | |
| Comparative | 578 | 1141 | 5079 | 2400 | 0.55 |
| Example 2 | | | | | |

The result indicates that the argyrodite-based solid electrolyte according to the present invention satisfies Equation 3 below:

0.20<A_{Peak-3}/(A_{Peak-1}+A_{Peak-2}+A_{Peak-3}+A_{Peak-4})<0.45 (3)

wherein A_{Peak-1} is an area of a Sb-XPS peak at a binding energy of 528.81±0.3 eV, A_{Peak-2} is an area of a Sb-XPS peak at a binding energy of 529.54±0.3 eV, A_{Peak-3} is an area of a Sb-XPS peak at a binding energy of 530.52±0.3 eV, and A_{Peak-4} is an area of a Sb-XPS peak at a binding energy of 532.04±0.3 eV.

The lithium-ion-conducting sulfide-based solid electrolyte according to the present invention can be used for all electrochemical cells that use solid electrolytes. Specifically, the lithium-ion-conducting sulfide-based solid electrolyte can be applied to a variety of fields and products, including those of energy storage systems using secondary batteries, batteries for electric vehicles or hybrid electric vehicles, portable power supply systems for unmanned robots or the Internet of Things, and the like.

As is apparent from the foregoing, the solid electrolyte according to the present invention has high lithium ion conductivity of about 9.25 mS/cm.

The effects of the present invention are not limited to those mentioned above. It will be understood that the effects of the present invention include all effects that can be inferred from the description of the present invention.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A solid electrolyte represented by the following Formula 1 and having an argyrodite-type crystal structure:
Li₅₊ₐ(Mb 1ₐM2₁₋ₐ)(A1_{b}A2_{4-b})(X1_{c}X2_{2-c}) (1)
wherein M1 includes at least one crystallogenic element selected from the group consisting of carbon (C), silicon (Si), germanium (Ge), tin (Sn) and lead (Pb) elements and combinations thereof,
M2 includes at least one pnictogen element selected from the group consisting of nitrogen (N), phosphorus (P), arsenic (As), antimony (Sb) and bismuth (Bi) elements and combinations thereof,
A1 and A2 each include at least one chalcogen element selected from the group consisting of oxygen (O), sulfur (S), selenium (Se) and tellurium (Te) elements and combinations thereof,
X1 and X2 each include at least one halogen element selected from the group consisting of fluorine (F), chlorine (CI), bromine (Br) and iodine (I) elements and combinations thereof, and
a, b and c satisfy 0≤a≤1, 0≤b≤4, and 0≤c≤2.

2. The solid electrolyte according to claim 1, wherein the solid electrolyte has peaks in ranges of 2θ=14.86°±0.50°, 17.12°±0.50°, 24.20°±0.50°, 28.38°±0.50°, 29.66°±0.50°, 34.34°±0.50°, 38.55°±0.50°, 42.40°±0.50°, 45.07°±0.50°, 49.29°±0.50° and 55.55°±0.50° upon measurement of X-ray diffraction (XRD) patterns using a CuKα-ray.

3. The solid electrolyte according to claim 1, wherein the solid electrolyte satisfies the following Equation 1:
40% <I₍₁₁₁₎/I₍₂₀₀₎×100<70% (1)
wherein I₍₁₁₁₎ is a diffraction intensity of an XRD peak at 2θ=14.86°±0.50°, and I₍₂₀₀₎ is a diffraction intensity of an XRD peak at 2θ=17.12°±0.50°.

4. The solid electrolyte according to claim 1, wherein the solid electrolyte has a ⁷Li-NMR spectrum peak at 5.8±0.5 ppm and 0±0.5 ppm.

5. The solid electrolyte according to claim 1, wherein the solid electrolyte satisfies the following Equation 2:
0% <I_{Peak-1}/I_{Peak-2}×100<20% (2)
wherein Iₚₑₐₖ₋₁ is an intensity of a ⁷Li-NMR spectrum peak at −5.8 ppm and Iₚₑₐₖ₋₂ is an intensity of a ⁷Li-NMR spectrum peak at 0 ppm.

6. The solid electrolyte according to claim 1, wherein the solid electrolyte has an Sb-XPS spectrum at 526 eV to 535 eV, and the spectrum is divided into four main peaks.

7. The solid electrolyte according to claim 1, wherein the solid electrolyte satisfies the following Equation 3:
0.20<A_{Peak-3}/(A_{Peak-1}+A_{Peak-2}+A_{Peak-3}+A_{Peak-4})<0.45 (3)
wherein Aₚₑₐₖ₋₁ is an area of a Sb-XPS peak at a binding energy of 528.81±0.3 eV, A_{Peak-2} is an area of a Sb-XPS peak at a binding energy of 529.54±0.3 eV, Aₚₑₐₖ₋₃ is an area of a Sb-XPS peak at a binding energy of 530.52±0.3 eV, and A_{Peak-4} is an area of a Sb-XPS peak at a binding energy of 532.04±0.3 eV.

8. A solid electrolyte represented by the following Formula 2 and having an argyrodite-type crystal structure:
Li_{5+a+d}(M1ₐM2₁₋ₐ)(A1_{b}A2_{4-b})(X1_{c}X2_{2-c}) (2)
wherein M1 includes at least one crystallogenic element selected from the group consisting of carbon (C), silicon (Si), germanium (Ge), tin (Sn) and lead (Pb) elements and combinations thereof,
M2 includes at least one pnictogen element selected from the group consisting of nitrogen (N), phosphorus (P), arsenic (As), antimony (Sb) and bismuth (Bi) elements and combinations thereof,
A1 and A2 each include at least one chalcogen element selected from the group consisting of oxygen (O), sulfur (S), selenium (Se) and tellurium (Te) elements and combinations thereof,
X1 and X2 each include at least one halogen element selected from the group consisting of fluorine (F), chlorine (CI), bromine (Br) and iodine (I) elements and combinations thereof, and
a, b, c and d satisfy 0≤a≤1, 0≤b≤4, 0≤c≤2 and −1≤d≤1.

9. The solid electrolyte according to claim 8, wherein the solid electrolyte has peaks in ranges of 2θ=14.86°±0.50°, 17.12°±0.50°, 24.20°±0.50°, 28.38°±0.50°, 29.66°±0.50°, 34.34°±0.50°, 38.55°±0.50°, 42.40°±0.50°, 45.07°±0.50°, 49.29°±0.50° and 55.55°±0.50° upon measurement of X-ray diffraction (XRD) patterns using a CuKα-ray.

10. The solid electrolyte according to claim 8, wherein the solid electrolyte satisfies the following Equation 1:
40% <I₍₁₁₁₎/I_{(200)×}100<70% (1)
wherein I₍₁₁₁₎ is a diffraction intensity of an XRD peak at 2θ=14.86°±0.50° and I₍₂₀₀₎ is a diffraction intensity of an XRD peak at 2θ=17.12°±0.50°.

11. The solid electrolyte according to claim 8, wherein the solid electrolyte has a ⁷Li-NMR spectrum peak at 5.8±0.5 ppm and 0±0.5 ppm.

12. The solid electrolyte according to claim 8, wherein the solid electrolyte satisfies the following Equation 2:
0% <I_{Peak-1}/I_{Peak-2}×100<20% (2)
wherein Iₚₑₐₖ₋₁ is an intensity of a ⁷Li-NMR spectrum peak at −5.8 ppm and Iₚₑₐₖ₋₂ is an intensity of a ⁷Li-NMR spectrum peak at 0 ppm.

13. The solid electrolyte according to claim 8, wherein the solid electrolyte has an Sb-XPS spectrum at 526 eV to 535 eV, and the spectrum is divided into four main peaks.

14. The solid electrolyte according to claim 8, wherein the solid electrolyte satisfies the following Equation 3:
0.20<A_{Peak-3}/(A_{Peak-1}+A_{Peak-2}+A_{Peak-3}+A_{Peak-4})<0.45 (3)
wherein Aₚₑₐₖ₋₁ is an area of a Sb-XPS peak at a binding energy of 528.81±0.3 eV, A_{Peak-2} is an area of a Sb-XPS peak at a binding energy of 529.54±0.3 eV, A_{Peak-3} is an area of a Sb-XPS peak at a binding energy of 530.52±0.3 eV, and A_{Peak-4} is an area of a Sb-XPS peak at a binding energy of 532.04±0.3 eV.

15. A method for preparing the solid electrolyte according to claims 1 comprising:
adding at least one element selected from the group consisting of a crystallogenic element, a pnictogen element, a chalcogen element and combinations thereof to a mixture containing lithium chalcogenide (Li₂A), chalcogenide (MSₓ) and lithium halide (LiX) to prepare a starting material; and
grinding the starting material.

16. The method according to claim 15, further comprising heat-treating the ground mixture at a temperature of 30° C. to 1,000° C. for 10 seconds to 1,000 hours.

17. A method for preparing the solid electrolyte according to claims 8 comprising:
adding at least one element selected from the group consisting of a crystallogenic element, a pnictogen element, a chalcogen element and combinations thereof to a mixture containing lithium chalcogenide (Li₂A), chalcogenide (MSₓ) and lithium halide (LiX) to prepare a starting material; and
grinding the starting material.

18. The method according to claim 17, further comprising heat-treating the ground mixture at a temperature of 30° C. to 1,000° C. for 10 seconds to 1,000 hours.
